(19) United States
(12) Patent Application Publication
(10) Pub. No.: US 2010/0011172 A1
(43) Pub. Date: Jan. 14, 2010

(54) MICROCONTROLLER SYSTEMS HAVING SEPARATE ADDRESS AND DATA BUSES

(75) Inventors: Jason Molgaard, Windsor, CO (US); Michael James, Longmont, CO (US); Bradford Lincoln, Boulder, CO (US)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/170,306

(22) Filed: Jul. 9, 2008

(51) Int. Cl. G06F 13/18; G06F 12/00

(52) U.S. Cl. 711/151; 711/E12.001

(57) ABSTRACT

A microcontroller system includes at least one processor and at least one storage unit for storing data received from or to be sent to the processor. At least two read clients are provided in the processor for retrieving data from the storage unit, and at least one write client is provided in the processor for writing data in the storage unit. The system further includes a memory device provided in the storage unit for storing data, and an arbitration device provided in the storage unit for enabling access to the memory device by the read and the write client. The read clients each have a dedicated read address line connected to the arbitration device for sending a read address of read data to be retrieved from the memory device, and a shared read data bus connected to the memory device for receiving the read data from the read address.

### FIELD OF INVENTION

The present invention relates to microcontroller systems, and in particular, to a microcontroller including arbitration devices for controlling access to storage devices by multiple clients through separate address buses and data buses.

### BACKGROUND OF THE INVENTION

Conventional microcontroller systems employ a single, shared address and data bus that are connected from a processor to all storage devices such as RAMs and registers within a system. Read and write operations share this same bus. As a result, only one address (and request) can be output in a cycle, and only one read or write data transfer can complete in a cycle. Consequently, the shared address and data bus limits system performance.

### SUMMARY OF THE INVENTION

The present invention is directed to a microcontroller system including at least one processor and at least one storage unit for storing data received from or to be sent to the processor. At least two read clients are provided in the processor for retrieving data from the storage unit, and at least one write client is provided in the processor for writing data in the storage unit. The system further includes a memory device provided in the storage unit for storing data, and an arbitration device provided in the storage unit for enabling access to the memory device by the read and the write client. The read clients each have a dedicated read address line connected to the arbitration device for sending a read address of read data to be retrieved from the memory device, and a shared read data bus connected to the memory device for receiving the read data from the read address.

### BRIEF DESCRIPTION OF THE DRAWINGS

FIG. 1 is a block diagram of a microcontroller system in accordance with one embodiment of the present invention;

FIG. 2 is a block diagram of a read arbitration client shown in FIG. 1;

FIG. 3 is a block diagram of a write arbitration client shown in FIG. 1; and

FIG. 4 is a block diagram of an arbiter shown in FIG. 1.

### DETAILED DESCRIPTION OF THE PREFERRED EMBODIMENTS

The present invention uses multiple address and data buses for reading operands and writing results. The read and write operations are performed by multiple arbitration clients each having an address bus, a data bus, and a mechanism for making requests and receiving grants, and an arbiter for determining which arbitration client is granted access to a given memory resource in a particular cycle. Each microcontroller contains two (or more) read arbitration clients and one (or more) write arbitration client. Thus, it is possible to read two (or more) operands and write one or more results in the same cycle.

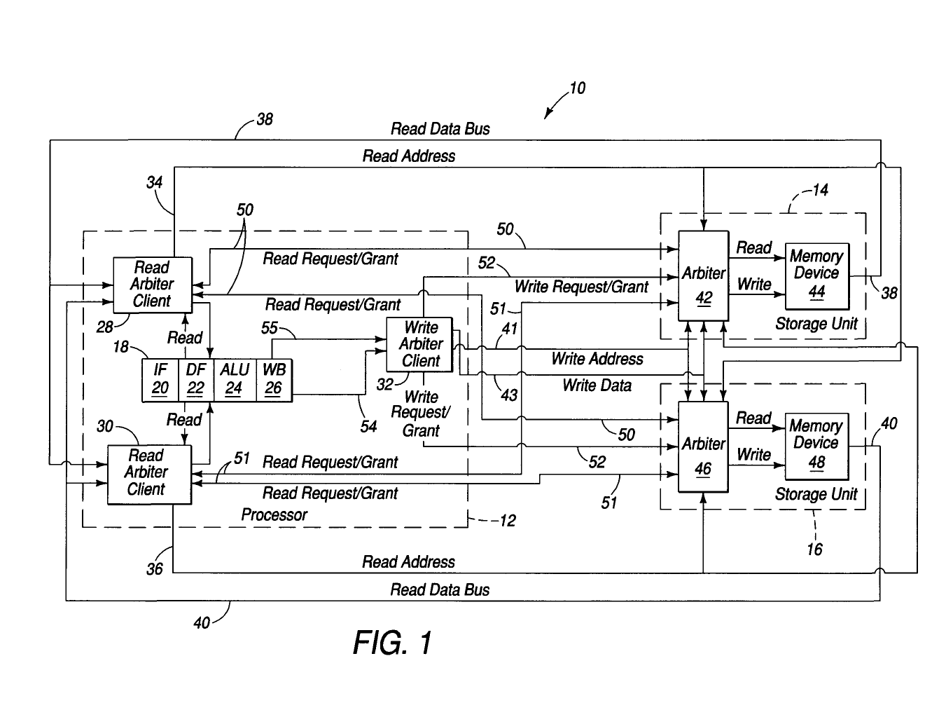

Turning now to FIG. 1, a block diagram of a microcontroller system 10 is shown in accordance with one exemplary embodiment of the present invention. The microcontroller system 10 includes a processor 12 and two or more storage units 14, 16 (two shown as an example). The processor 12 controls the overall operation of the microcontroller system 10, including arithmetic and logic operations. The processor 12 uses pipeline processing so that more than one instruction can be executed without waiting for the first instruction to be completed. Accordingly, the processor 12 includes an instruction pipeline 18 which is divided into multiple stages containing instructions at various points of execution.

In the preferred embodiment, the instruction pipeline 18 requires at least an instruction fetch (IF) stage 20 for locating and retrieving the next instructions into the processor 12 for execution, a data fetch (DF) stage 22 for retrieving data from the storage units 14, 16 as specified by the instructions in the IF stage, and an arithmetic logic unit (ALU) stage 24 for performing calculations. The instruction pipeline 18 also includes a write back (WB) stage 26 for writing any results that were computed in the ALU stage to the storage units 14, 16.

The processor 12 also includes a pair of read arbitration (ARB) clients 28, 30 for fetching data from the storage units 14, 16 during reading operations, and a write arbitration (ARB) client 32 for writing data to the storage units during writing operations, as instructed by the write back stage 26 of the instruction pipeline 18. The read ARB clients 28, 30 each have a dedicated read address lines 34, 36, respectively, for enabling the processor 12 to fetch data from the two storage units 14, 16, in parallel, through shared read data bus lines 38 or 40. The write ARB client 32 has a dedicated write address line 41 for carrying the addresses to the memory units 14, 16 in which to store data, and a separate write data bus 43 for carrying data to be stored in the addresses indicated in the write address line.

Thus described arrangement of the microcontroller system 10 enables the two read ARB clients 28, 32 to fetch two operands from two different storage units 14, 16 simultaneously, and the write ARB client 32 to output a single result. While only two read ARB clients 28, 30 and one write ARB client 32 are shown and described, any additional read and write ARB clients may be added to the processor 12, and each would have the same configuration.

The storage unit 14 includes an arbiter 42 and a memory device 44, and the storage unit 16 includes an arbiter 46 and a memory device 48. In the exemplary embodiment, the memory devices 44 and 48 are two port RAMs. However, other storage units such as registers and peripheral interfaces may be used in place of or along with RAMs, depending on the intended use of the microcontroller system 10. Moreover, the two port memory devices 44, 48 may be implemented using a three port RAM that allows two reads and one write simultaneously. This would enable the read ARB clients 28, 30 to fetch two operands from the same one of the storage units 14, 16 simultaneously.

Each of the arbiters 42 and 46 is communicatively connected to the read ARB clients 28, 30, and the write ARB client 32. The arbiters 42, 46 receive read and write requests from these sources, and grants access to the corresponding memory devices 44 or 48. More specifically, the arbiters 42 and 46 each receives read addresses from the read ARB clients 28 and 30 through the read address lines 34, 36. The arbiters 42 and 46 also receive read requests from and grant accesses to the ARB clients 28, 30 through a corresponding read request/grant lines 50, 51. Thus, the read ARB client 28 is connected to both arbiters 42 and 46 via the read address line 34 and two separate read requests/grant lines 50 each going to the corresponding arbiter. Similarly, the read ARB client 30 has the read address line 36 going to both of the arbiters 42 and 46, and two separate read requests/grant lines 51 each going to their respective arbiters.

The write ARB client 32 includes two separate write requests/grant lines 52, each going to the corresponding arbiter 42 or 46, the write address line 41 which is connected to both of the arbiters, and the separate write data line 43 that also goes to both arbiters 42 and 46. The write ARB client 32 is also connected to the instruction pipeline 18, specifically the write back (WB) stage 26 for receiving write instructions from the instruction pipeline via a write line 55, and for receiving data to be written via a dedicated write data line 54. Thus, the arbiters 42 and 46 each receives write requests from and grants accesses to the write ARB client 32 through the dedicated write request/grant line 52, a write address from the write ARB client 32 through the write address line 41, and the write data through the write data line 43.

The memory devices 44, 48 store data used by the processor 12, and receive read and write signals from their respective arbiters 42, 46. The memory devices 44, 48 output data requested by the read ARB clients 28, 30 through the corresponding read data bus 38 and 40, each of which are shared by read ARB clients 28 and 30.

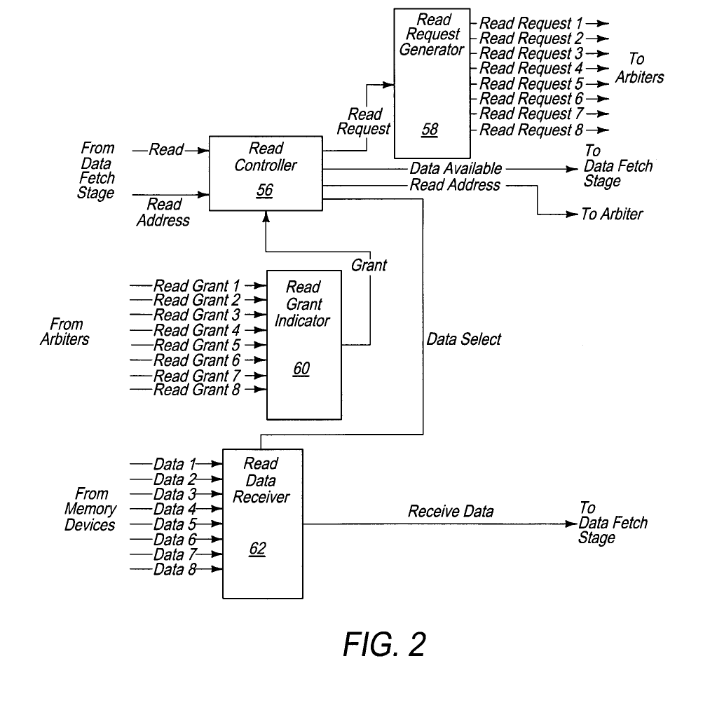

Referring to FIG. 2, the read ARB clients 28, 30 each includes a read controller 56, a read request generator 58, a read grant indicator 60 and a read data receiver 62. The read controller 56 is preferably hardwired control logic for receiving a data fetch request from the data fetch (DF) stage 22 of the instruction pipeline 18. More specifically, the read controller 56 receives a READ signal indicating that data is needed, and a READ ADDRESS signal providing the address of the targeted data in the memory devices 44 or 48. The READ signal and the READ ADDRESS signals are received simultaneously from the data fetch stage 22. The read controller 56 then outputs a read request signal to the read request generator 58, which analyzes the target address and sends a READ REQUEST signal to the appropriate arbiter 42 or 46 via the read request/grant line 50 or 51 corresponding to the memory devices 44 or 48 in which the targeted data is located. Accordingly, the read request generator 58 has number of outputs corresponding to the number of the memory devices in the system 10. Preferably, the read request generator 58 is implemented using a demultiplexer. The READ ADDRESS of the targeted data is communicated to the appropriate arbiter 42 or 48 by the read controller 56 via the corresponding READ ADDRESS lines 34 or 36.

When the arbiter 42 or 46 corresponding to the targeted memory device 44 or 48 decides to grant access to the read ARB client 28 or 30 issuing the read request signal, it sends a READ GRANT signal to the read grant indicator 60 in the read ARB client, through the read request/grant line 50 or 51 (see FIG. 1). Simultaneously, the memory device 44 or 48 also sends the requested data to the read data receiver 62 in the same read ARB client through the corresponding read data bus 38 or 40. Both the read grant indicator 60 and the read data receiver 62 are implemented using multiplexers. The read grant indicator 60 includes inputs corresponding to the number of arbiters that are in the microcontroller system 10, and the read data receiver 60 has number of inputs corresponding to the number of the memory devices in the system 10.

Upon receiving the READ grant signal from the arbiter 42 or 46 of the targeted memory device 44 or 48, the read grant indicator 60 sends a grant signal to the read controller 56. In response, the read controller 56 outputs a DATA AVAILABLE signal to the data fetch stage 22 of the pipeline 18 indicating that the requested data is available. The data fetch stage 22 of the read ARB client 28 or 30 requesting the read request then receives the data from the read data receiver 62. A data select signal is also output by the read controller 56 to the read data receiver 62 indicating which of the read data received from the memory device 44 or 48 corresponding to the targeted data should be output by the read data receiver.

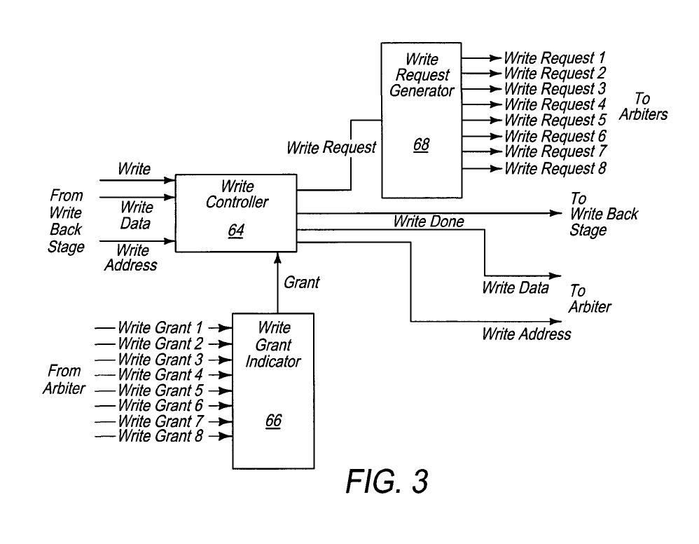

Referring now to FIG. 3, the write ARB client 32 includes a write controller 64, a write grant indicator 66, and a write request generator 68. The write controller 64, similar to the read controller 56, is implemented using hardwired control logic. The write grant indicator 66 is implemented using a multiplexer, and the write request generator 68 using a demultiplexer.

The write controller 64 receives a WRITE signal indicating that a write process is needed, a WRITE ADDRESS signal providing the destination address of the write data in the memory devices 44 or 48, and data (WRITE DATA) to be written in the target address. The WRITE and WRITE ADDRESS signals are received simultaneously from the write back (WB) stage 26 via the write lines 55, and the WRITE DATA via the write data line 54. The write controller 64 outputs a write request signal to the write request generator 68, which analyzes the target address and sends a WRITE REQUEST signal to the appropriate arbiter 42 or 46 corresponding to the memory devices 44 or 48 where the data will be written. In conjunction with the WRITE REQUEST signal, the write controller 64 also outputs the WRITE ADDRESS on the dedicated write address line 41 and the WRITE DATA on the separate write data bus 43 to the same arbiter 42 or 46.

When the arbiter 42 or 46 corresponding to the targeted memory device 44 or 48 decides to grant access to the write ARB client 32, it sends a WRITE GRANT signal to the write grant indicator 66 in the write ARB client via the write request/grant line 52. The grant indicator 66 then sends a grant signal to the write controller 64, which outputs a WRITE DONE signal to the write back stage 26 of the instruction pipeline 18 indicating that the write process has been completed.

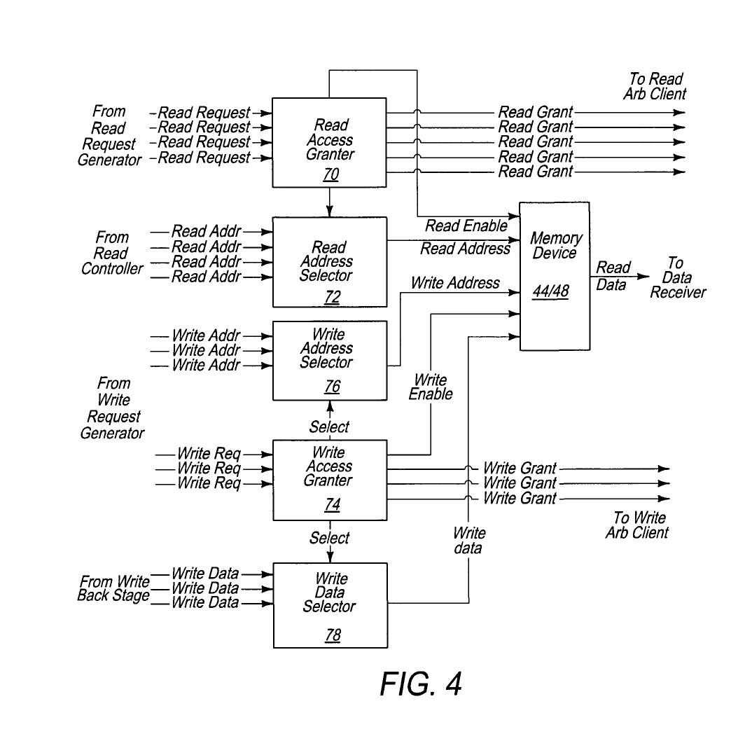

Turning now to FIG. 4, the arbiters 42, 46 each include a read access granter 70 and a read address selector 72 for handling read requests from the read ARB clients 28, 30. Each of the arbiters 42, 46 also includes a write access granter 74, a write address selector 76 and a write data selector 78 for handling write requests from the write ARB client 32.

The read access granter 70 receives a READ REQUEST from all the read ARB clients 28, 30 (and any additional read ARB clients in the microcontroller system 10 or other microcontroller systems), and outputs READ GRANT signals indicating to the read ARB client 28 or 30 that an access has been granted. In addition to these outputs, the read access granter 70 further communicates to the read address selector 72, the read ARB client given access to the requested data. Based upon the signal received from the read access granter 70, the read address selector 72 receives the corresponding address from the selected read ARB client 28 or 30, and outputs the selected READ ADDRESS to the memory device 44 or 48.

The read access granter 70 further outputs a read enable signal to the memory device 44 or 48, so that the memory device 44 or 48 outputs the data from the memory location indicated in the selected read address received from the read address selector 72. The data read from that address (memory location) is output by the memory device 44 or 48 to the corresponding read data bus 38 or 40, which carries the data to the read ARB client 28 or 30 requesting the data, specifically, to the data receiver 62 of the read ARB client.

In one embodiment, the read access granter 70 employs a priority encoded method of determining access by the competing read ARB clients, and a single grant is generated in response to the highest priority request. However, other arbitration schemes may be used, such as the round robin or the first-come, first-served methods.

The write access granter 74 receives WRITE REQUEST signals from the write ARB client 32 (or any additional write ARB clients in the microcontroller system 10 or other microcontroller systems) and determines, based upon the type of arbitration scheme used, which of the WRITE REQUEST signals is selected for operation in the targeted memory device 44 or 48. Once the write access granter 74 selects the WRITE REQUEST signal from the write ARB clients, it outputs a select signal to the write address selector 76 and to the write data selector 78. The write address selector 76 allows the WRITE ADDRESS corresponding to the selected write ARB client to be supplied to the memory device 44 or 48. The write data selector 78 selects the WRITE DATA corresponding to the selected write ARB client and sends the selected WRITE DATA to the memory device 44 or 48, where the data is written to the indicated WRITE ADDRESS from the write address selector 76. The write access granter 74 also outputs WRITE GRANT signals that are sent to the grant indicator 66 of the write ARB client 32 via the write request/grant line 52. A write enable signal output from the write access granter 74 enables the target memory device 44 or 48 to store the WRITE DATA received from the write data selector 78 in the WRITE ADDRESS indicated by the write address selector 76.

The write access granter 74 and the read access granter 70 are implemented in hardwired logic, and the read address selector 72, the write address selector 76 and the write data selector 78 are implemented using multiplexers.

In operation, if the two read ARB clients 28 and 30 within the processor 12 target different memory devices 44 and 48, data for both read ARB clients can return in the same cycle. However, if the same memory device 44 or 48 is targeted, the data must be returned serially from the targeted memory device to the read ARB clients 28 and 30. In this case, each of the read ARB clients 28 and 30 makes its request to the appropriate arbiter 42 or 46, and the arbiter determines which read ARB client is granted access first.

It should also be appreciated that the order data is fetched is not predetermined. This prevents stalled data fetches from delaying data fetches that would otherwise not stall. For example, when one memory device 44 or 48 is able to provide a grant immediately but the other cannot, one read will complete even if it is the “second” data requested.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. A microcontroller system including at least one processor and at least one storage unit for storing data received from or to be sent to the processor, said system comprising:
at least two read clients provided in the processor for retrieving data from the storage unit;
at least one write client provided in the processor for writing data in the storage unit;
a memory device provided in the storage unit for storing data; and
an arbitration device provided in the storage unit for enabling access to the memory device by the read clients and the write client;
wherein the read clients each have a dedicated read address line connected to the arbitration device for sending a read address of read data to be retrieved from the memory device, and a shared read data bus connected to the memory device for receiving the read data from the read address.

2. The system as defined in claim 1, wherein each of the read clients comprises:
a read controller for outputting the read address and a read request signal requesting access to the read address, to the arbitration device;
a read grant indicator for receiving a read grant signal from the arbitration device indicating that the access request has been granted; and
a data receiver for receiving from the memory device the read data requested in the read request signal.

3. The system as defined in claim 2, wherein the read client transmits the read request signal and receives the read grant signal via a dedicated connection line between the read client and the arbitration device.

4. The system as defined in claim 2, wherein the read client further comprises a read request generator for routing the read request signal output by the read controller to the arbitration device.

5. The system as defined in claim 4, wherein the read request generator comprises a demultiplexer, and the read grant indicator and the read data receiver comprise multiplexers.

6. The system as defined in claim 1, wherein the write client has a dedicated write address line connected to the arbitration device for sending a write address in the memory device in which to store write data, and a dedicated write data bus connected to the arbitration device for sending the write data to the write address.

7. The system as defined in claim 6, wherein the write client comprises:
a write controller for outputting the write address in the memory device, and a write request signal requesting access to the write address, to the arbitration device;
a write grant indicator for receiving a write grant signal from the arbitration device indicating that the access request has been granted.

8. The system as defined in claim 7, wherein the write client transmits the write request signal and receives the write grant signal via a dedicated connection between the write client and the arbitration device.

9. The system as defined in claim 7, wherein the write client further comprises a write request generator for routing the write request signal output from the write controller to the arbitration device.

10. The system as defined in claim 9, wherein the write request generator comprises a multiplexer, and the write grant indicator comprises a multiplexer.

11. The system as defined in claim 1, wherein the arbitration device comprises:
a read access granter for receiving read request signals from the read clients, and granting access to a read address in the memory device requested by a selected one of the read clients;
a read address selector for receiving read addresses from the read clients and selecting and sending the read address corresponding to the selected read client to the memory device;
a write access granter for receiving a write request signal from the write client, and granting access to the write address in the memory device requested by the write client;
a write address selector for receiving the write address from the write client and sending the write address to the memory device; and
a write data selector for receiving the write data from the write client and sending the write data to the memory device;
wherein the read access granter enables the memory device to output the read data requested by the selected read client, and the write address granter enables the memory device to store the write data received from the write client.

12. The system as defined in claim 11, wherein the write access granter receives a plurality of write request signals from a plurality of write clients, and selects one of the write clients to which to grant access to the write address;
the write address selector receives a plurality of write addresses and selects the write address corresponding to the write client selected by the write access granter; and
the write data selector receives a plurality of write data and selects the write data corresponding to the write client selected by the write access granter.

13. The system as defined in claim 12, wherein the read access granter grants access to the read address, and the write access granter grants access to the write address based on a priority encoded method.

14. The system as defined in claim 1, comprising a plurality of storage units and a plurality of read clients, wherein the plurality of read clients are configured to receive data from the plurality of storage units simultaneously.

15. A microcontroller system including a processor and at least two storage units for storing data received from or to be sent to the processor, said system comprising:
at least two read clients provided in the processor for retrieving data from the storage units;
at least one write client provided in the processor for writing data in the storage device;
a memory device provided in each of the storage units for storing data; and
an arbitration device provided in each of the storage units for arbitrating access to the corresponding memory device between the read clients and write clients;
wherein the read clients each have a dedicated read address line connected to the arbitration devices for sending an address of read data to be retrieved from the memory device, and a shared data bus connected to the memory devices for receiving the read data from the read address in the memory device; and
the write client has a dedicated write line connected to the arbitration devices for sending a write address in the memory device in which to store write data, and a dedicated write data bus connected to the arbitration device for sending write data to the write address.

16. The system as defined in claim 15, wherein the read clients sends read request signals and receive read grant signals from the arbitration devices via a connection line provided between each of the read clients and each of the arbitration devices, and the write client sends a write request signal and receives write grant signals from the arbitration devices via a connection line between the write client and the arbitration devices.

17. The system as defined in claim 16, wherein each of the arbitration device of the selected storage unit receive the read request signals from the read units, and selects a read request signal to which to grant access.

18. The system as defined in claim 17, wherein the arbitration device selects the read request signal based on a priority encoded method.

19. The system as defined in claim 15, wherein the two read clients are configured to receive data from the two storage units simultaneously.
